(19) United States
(12) Patent Application Publication
(10) Pub. No.: US 2017/0118975 A1
(43) Pub. Date: May 4, 2017

(54) IN-GROUND BARRIER FOR BLOCKING INSECTS AND RODENTS FOD ACCESS TO RUNWAYS

(71) Applicant: FOD Guard Wildlife Management Corp., Comox (CA)

(72) Inventor: Kenneth Speckeen, Comox (CA)

(21) Appl. No.: 15/339,333

(22) Filed: Oct. 31, 2016

Related U.S. Application Data
(60) Provisional application No. 62/248,051, filed on Oct. 29, 2015.

(51) Int. Cl. A01M 23/08; B64F 1/36; A01M 1/10; A01M 1/20; A01M 25/00

(52) U.S. Cl. CPC A01M 23/08; A01M 1/20; A01M 25/002; A01M 1/10; B64F 1/36

(57) ABSTRACT

The in-ground barrier for blocking insects and rodents FOD access to runways has a main trough or body having a bottom part and two parallel upright and opposing walls, an inclined board mounted, so as to be pivotable with respect to the outer upright wall and a lid pivotably mounted at the opposite upright or inner wall. Rodents and insects slide on the inclined board and will fall in the trough and are not able to crawl back, so as to escape or pass across the barrier, thereby being blocked from the runway.

### FIELD OF THE INVENTION

The present invention relates to a safety device for airports or airfields runways, more particularly to an in-ground barrier for blocking insects and rodents FOD (foreign object debris/damage) of having access to the runways and taxiways of airport or airfield areas.

### BACKGROUND OF THE INVENTION

It is well-known that birds, insects and rodents are a serious hazard to aviation. The water and nesting materials lead to potentially dangerous safety problem, bird and animal strikes. Many birds including gulls, waterfowl, raptors such as hawks and other species flock to airfields to eat, drink and reproduce. Birds eat insects, earth worms and grubs which live in natural grass and which often migrate onto the runways at night, especially after a rain. Birds also eat rodents, which feed on the insects. Standing water, especially after fresh rain, attracts many species of birds, including waterfowl. Large birds such as ducks or geese also create especially dangerous conditions for aircraft and are classified as FOD (Foreign object damage/debris). Natural grass further provides materials and cover for birds to nest and breed. Simply put, birds are found where their food source is found, which accounts for their presence on and around runways and taxiways. Accordingly, many airports and airfields report collisions between airplanes and birds and other animals.

Most airports support an abundance and variety of foods such as seeds, berries, grass, insects, grubs, earthworms, small birds, and small mammals. Seeds and berries are sought by several migratory and resident birds such as sparrows, finches, starlings, blackbirds, mourning doves, common pigeons, and waterfowl. Geese are attracted to open expanses of grasses. Gulls, starlings, robins, and crows often feed on earthworms on the surface of the ground, or on a runway, following a rain. Gulls are opportunistic feeders and frequently feed on grasshoppers and ground-nesting birds.

Damage caused to aircraft usually results from collision of one or more birds with the engines and/or fuselage. Although most bird strikes do not result in crashes, they do involve expensive structural and mechanical damage to aircraft. The incidence of this problem worldwide makes bird strike a serious economic problem.

During the early days of aviation, when aircraft flew at slow speeds, birds had little difficulty in getting out of the way. Bird strikes were infrequent and damage was mainly confined to cracked windshields. The likelihood of the loss of aircraft and/or human lives was remote. With the development and introduction of jet aircraft, bird strikes became a serious hazard and costly problem. Faster speeds mean birds have less time to react to approaching aircraft. The force generated by bird impact with a fast-moving aircraft can be tremendous. The newer turbine engines use light-weight, high-speed mechanical parts which are vulnerable to bird strike damage.

The Federal Aviation Administration (FAA) prescribes rules governing wildlife hazard management at certified airports in the Federal Aviation Regulations: Part 139. The USDA-APHIS-Wildlife Services program recognizes the potential for aircraft accidents and loss of human life and considers bird hazards to aircraft a top priority. This program provides technical assistance to alleviate bird hazards to civilian airports and military airbases.

Consequently, many wholly or partly attempts have been made to solve the bird-strike issues mentioned above unsuccessful. Barriers to rodent movement or burrowing, so as block a food supply for birds, were considered in the past. The ability of rodents to construct and maintain burrow systems were reduced by heavy compaction of the site's soil where vegetation occurs over it. Alternatively, a substrate (e.g., gravel, very fine sand) less supportive of intact burrows was also used. Another solution was to place a layer of mesh or woven material placed over the surface that would allow grass to grow through, so this would not allow rodents to move between the surface and the subsurface. Finally, a barrier (e.g., cement or metal flashing) was established at the perimeter fence, extending at least 25 cm (10 inches) above and below the soil surface to restrict rodent dispersal on to the airport proper. An alternative to this type of barrier would be a shallow, horizontal trench extending out from the perimeter fence about 5 meters (16.4 feet) filled with gravel or other material that would make above and below ground movement difficult for rodents. Of course, these barriers would only be effective if the existing rodent population within the perimeter could be successfully eliminated, or greatly reduced, by the use of rodenticides within the perimeter fence. Also, tall vegetation or deep snow cover may allow rodents to gain access over vertical barriers.

Applicant's initial focus when creating this invention was about solving the worms' issue, as runways throughout the world are littered with worms after a rain. Consequently, gulls account for over half the bird strikes in North America and Europe, as they flock to airports for these worms. To this point the only available solutions are costly, short term and not environmentally friendly. One alternative involves sweeping, which costs for equipment and manpower. This option requires redoing almost every day in rain areas and most airports cannot afford to have them on the runways do to operations. In addition, sweeping tends to break up the worms and spread them out more, which also attracts the gulls. Another alternative requires the constant spraying of pesticides, which needs constant reapplication and is not environmental friendly.

Therefore, in order to overcome all the issues mentioned above, the applicant has created a safety device that can be used in airports, especially around airfields runways and taxiways. The device is an in-ground barrier for blocking insects and rodents FOD from access to the runways and taxiways of airports or airfield areas. The barrier described below is illustrative and does not limit the scope of the present invention.

Applicant is aware of the following publications:

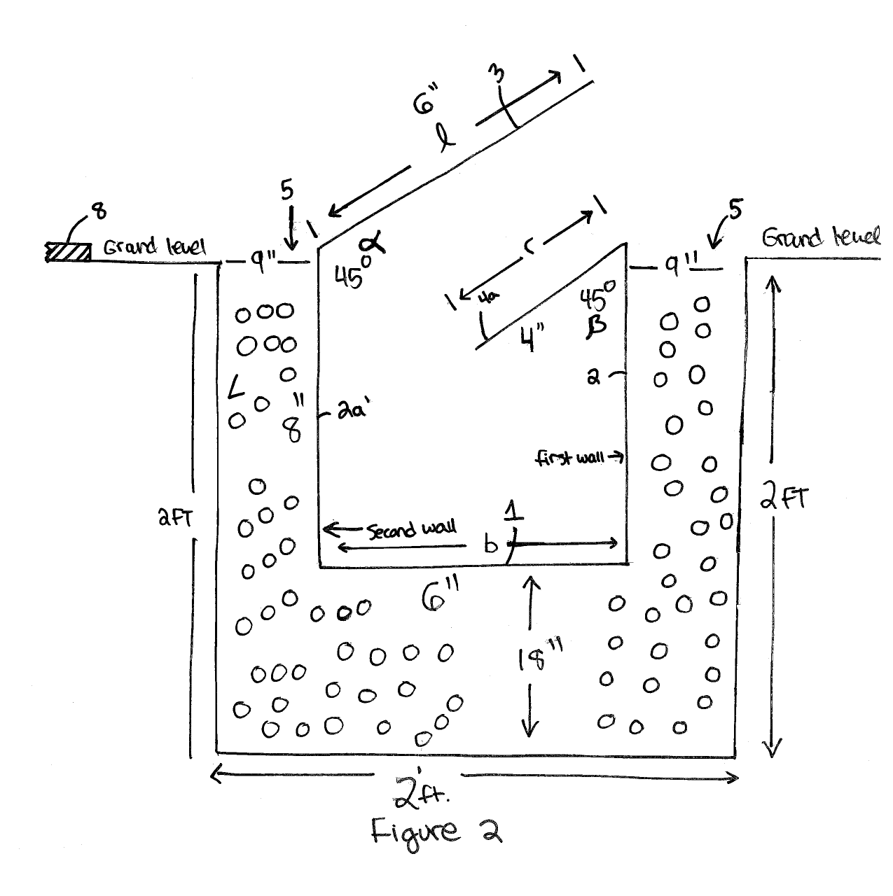

U.S. Pat. No. 639,246 to Kagarier, entitled “Animal Trap” discloses an animal trap wherein the lid J is raised and the hook K baited and the lid again closed, in which position the trap is ready for operation. An animal passing over the metal plate M upon the trap-door M will cause the trap-door to fall into the position indicated by dotted lines in FIG. 2, which will drop the animal into the main body, from which it may be removed, when desired, by opening the slide-door P. Should the animal proceed far enough into the trap to place his feet upon the incline I, it will be unable to secure a hold thereon when the trap-door falls, and the incline will prevent the animal from obtaining a foothold upon the top of the trap beyond the trap-opening. The open top and bottom box G will act as a fender to prevent any attempt of escape from the main trap.

U.S. Pat. No. 2,054,730 to Pierpoint entitled “Roach Trap” describes a trap comprising a box-like body 5, preferably substantially of rectangular shape, although it may be of any other shape to present flat vertical side and end walls 6 and 1, respectively. The opposite side wall 6 of this body 5 at the top edge thereof have the comparatively narrow sloping or inwardly-inclined ledges 8, these being cut and bent from the blank forming the body 5 and constitute guards. Within the body 5, a suitable bait for enticing roaches or other like pests within and the latter will crawl up the plates or run-ways for entrance to the body or they will crawl upon the wall of the enclosure and make entrance to the body 5 therefrom by way of the ledge 8 next thereto. The roaches or the like on crawling upon the ledges 8 and 10 will fall therefrom into the said body and thus become trapped therein. It is impossible for the roaches caught within the trap to make an exit therefrom as the ledges 8 and 10, respectively function as a, barrier for so doing.

U.S. Pat. No. 5,926,999 to Vernon et al. entitled “Portable Trench Barrier for Insects Pests in Agriculture” describes a portable trench barrier for reducing the number of beetles migrating into a cultivated area, such as a field of potato plants. The device comprises a series of linear barrier sections and connector pieces joined together to enclose and protect a cultivated area. Each linear barrier section comprises an extruded plastic section having (a) an elongated floor section, (b) a pair of continuous leg portions extending downwardly from the side edges of the floor portion. The leg portions are adapted to penetrate the soil and form a continuous sub-surface barrier. A pair of opposed upwardly inclined elongated ramp portions extending upwardly and inwardly from the side edges of the floor portion, these ramp portions terminating in downwardly curved free edge portions having smooth outer surfaces with the curved free edge portions of the opposed ramp portions forming therebetween a gap having a width of up to about 20 mm. The opposed ramp portions and gap are arranged such that beetles are able to climb the ramp and continue along the ramp until they reach a point on the curved free edge portion where they lose their footing and slide down into and are trapped in a chamber formed by the floor section and ramp portions.

U.S. Pat. No. 5,097,641 entitled “Method and apparatus for preventing termites, crawling insects or other crawling pests from entering residential structures, commercial structures and industrial structures” and U.S. Pat. No. 5,303,523 entitled “Pest preventer for location on a structural foundation support or a structure supporting a food source” both disclose a barrier located on a structural foundation support which is disposed between ground and a structure to be protected, and which prevents a crawling pest of a predetermined size from reaching the structure via the foundation support.

United States Published Application No. 2013140400, published Jun. 6, 2013, entitled “Foreign object debris barrier for runways” discloses a side barrier to FOD from entering a runway and taxiway and endangering aircraft. The barrier attaches to the ground and is constructed to collapse if the landing wheels of an aircraft impact the barrier to thus allow the aircraft to safely continue landing/take-off/taxiing.

In applicant's experience, one of the way of inhibiting the presence of insects and rodents, which consequently will also reduce the presence of birds in airports and airfields, is to use the present invention, which discloses an in-ground barrier for blocking insects and rodents FOD from having access to the runways and taxiways of airport or airfield areas.

### SUMMARY OF THE INVENTION

The present invention relates to a safety device for airports or airfields runways, more particularly to an in-ground barrier for blocking insects and rodents FOD from having access to the runways and taxiways of airport or airfield areas.

The in-ground barrier for blocking insects and rodents FOD access to runways comprises a trough having a bottom part and two parallel upright and opposing walls, configured in a “U” shape when viewed in the lateral cross-section (i.e. at right angles to the longitudinal axis of the trough). An inclined ramp is mounted to an upper edge of a first upright wall, so as to form an included angle β with the first wall. A frangible lid is mounted at the upper edge of the opposite second upright wall having an angle α, relative to the second wall. The ramp extends down into the elongate trough defined by the bottom and walls, without its distal cantilevered edge 4a touching the bottom or second wall. Rodents and insects FOD enter in the opening between the lid and the ramp to slide or otherwise move down the downwardly inclined ramp and fall to the bottom part, being unable to crawl to back up.

Additional objects, advantages and novel features of the present invention will be set forth in part in the description which follows and in part will become apparent to those skilled in the art upon examination of the following specification or may be learned by practice of the invention. To the accomplishment of the above-related objects, this invention may be embodied in the forms illustrated in the accompanying drawings, attention being called to the fact, however, that the drawings merely are illustrative, and that changes may be made in the specific construction illustrated and described within the scope of the appended claims.

### DEFINITIONS

Unless defined otherwise, all technical and scientific terms used herein have the same meaning as commonly understood by one of ordinary skill in the art to which this invention belongs.

As used herein, the terms:

Bird Strike—means when birds or other animals collide with an airplane. It happens when a bird or a flock of birds suddenly rises from a runway or surrounding area and they may collide with an incoming or departing aircraft causing it the aircraft to crash and possibly resulting in the loss of human life.
FOD (Foreign object damage/debris)—is an acronym often used in aviation to describe both the damage done to aircraft by foreign objects, and the foreign objects themselves.
Insect—includes all types of insects, worms, earthworms and pests, such as termites, arthropods, snails, slugs etc.
Rodents—comprise rats, mice, etc.

### DETAILED DESCRIPTION

In order to solve the problems described above, the present invention provides a safety device for airports or airfields runways, more particularly an in-ground barrier for blocking insects and rodents FOD from having access to the runways and taxiways of airport or airfield areas.

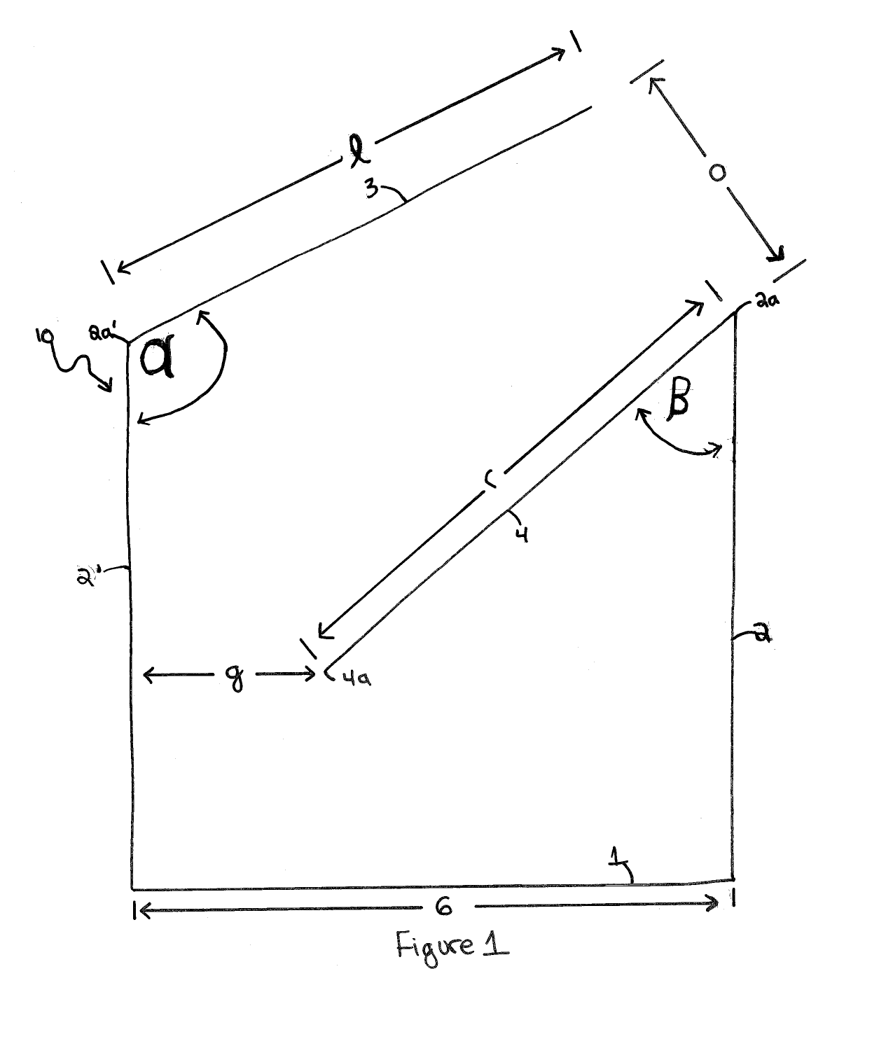

FIG. 1 is a representation of an in-ground barrier, showing in cross section the trough (10) which includes a bottom part (1), two parallel upright and opposing walls (2—outer wall and 2′—inner wall), a frangible lid (3) and a downwardly inclined ramp (4).

FIG. 2 is the cross-sectional view of FIG. 1, showing the barrier mounted in the ground in a trench and surrounded by gravel (5). By way of example, and without intending to be limiting, measurements are shown, illustrating the height by which the bottom (1) is elevated above the floor of the trench (18 inches), the distance between the floor of the trench and ground level (24 inches), and the space between the trough (10) and the walls of the trench (9 inches).

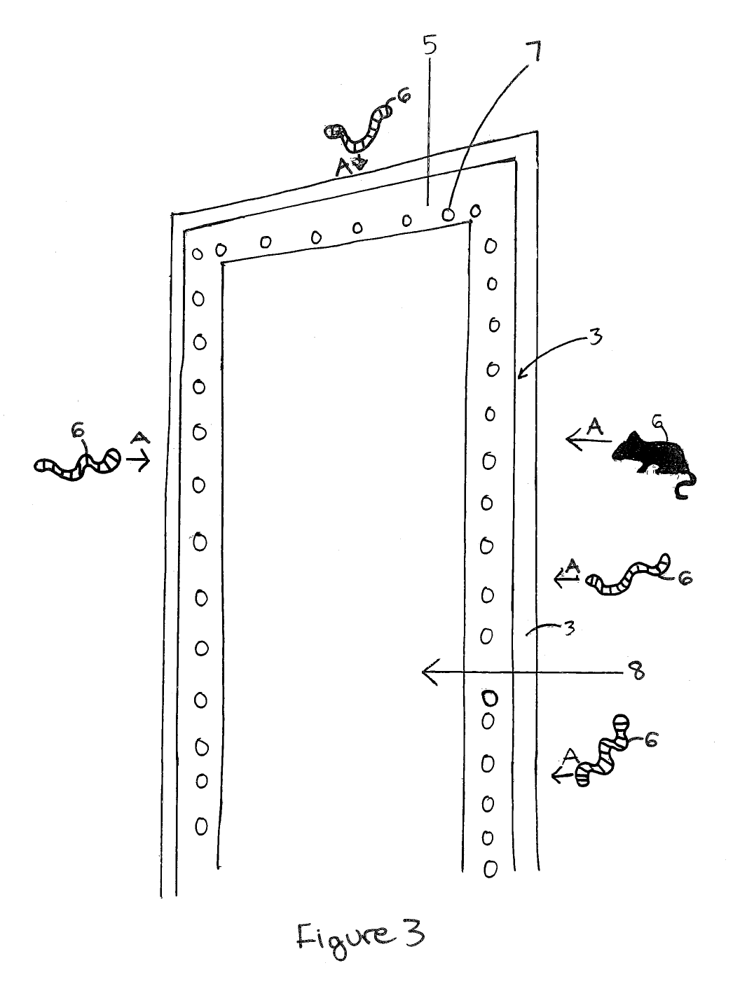

FIG. 3 represents a plan view of the barrier, in a birds-eye view looking down on lid 3 covering trough 10 surrounding runway 8. In an alternative embodiment, not shown, trough 10 may extend between runway lights 7. Lid (3), and partially ramp 4 depending on the angle of the viewing from above, block a view down into trough (10). FOD 6 is shown approaching the barrier in direction A.

Thus, as summarized above, the in-ground barrier for blocking insects and rodents FOD access to runways comprises a trough (10) having a bottom (1) and two parallel upright and opposing walls—outer wall 2 and inner wall 2′, wherein wall 2′ is closest to the runway, configured in a “U” shape cross-section. A ramp (4) is mounted to, and is downwardly inclined into, trough (10) from an upper edge 2a of outer wall 2. Ramp 4 forms an angle β with wall 2. A lid (3) is mounted to the top edge of 2a′ of the opposite upright wall, so as to from an angle α. Rodents and insects FOD slide or move downwardly on the ramp (4) and fall to the bottom (1). They are unable to crawl back up out of the trough (10) formed by the bottom (1) and the side walls 2 and 2′, as the upper edges 2a′ and 2a are blocked by lid (3) and ramp (4) respectively.

Advantageously, according to a further aspect of the invention, the lid may be frangible in the sense that it is downwardly collapsible.

The width “r” of the ramp (4) is less than the width “l” of the lid (3), so that the terminating edge 4a of ramp (4) is not in contact with the bottom (1) or with wall 2′. The width “r” of the ramp (4) may be almost equal to the width “b” of the bottom (1) so that there is a small gap “g” between the ramp (4) and the opposing wall.

In another aspect of the invention, both the lid (3) and the ramp (4) are respectively configured in angles α and β, wherein angle β may be in the range of 15-60°. Angle α may be equal to or different from angle β plus 90°.

In another aspect of the invention the bottom, walls, lid and ramp may be fabricated from a low-friction material which provides little or otherwise insufficient traction on the surfaces thereof for the insects and rodents to crawl back up out of the trough.

In another embodiment the trapped insects and rodents are exterminated with insecticide, rodenticide or other means applied into the trough.

The in-ground barrier for blocking insects and rodents FOD access to runways may further be provided with drainage channels (not shown), which are useful in draining water from trough (10), for example, as a result of run-off from standing water on the runway resulting from rain.

The in-ground barrier for blocking insects and rodents FOD access to runways of the present invention works as follows:

(a) Rodents and insects walk or otherwise move over the downwardly inclined ramp (4) and slide/fall into the trough (10) main cavity, defined by the bottom and sidewalls, where they are trapped and not able crawl out.
(b) Insecticide, rodenticide or other means to kill FOD may be placed into trough.
(c) To clean and empty trough (10), water ducts (not showed in the figures) may be provided to flush away the dead FOD, for example, to repositories, were they are discharged and/or otherwise disposed of.
(d) Lid (3) is frangible so that easily collapses and closes over through (10), when compressed by a landing wheel of an airplane or other vehicle running on its surface, so as to allow an aircraft departing the runway to do so unimpeded by the barrier.
(e) Lid (3) provides a cover that, in conjunction with ramp (4), completely blocks or occludes seeing into bottom (1) of the trough (10) from an aerial or birds-eye view. Thus birds will not be able to see insects trapped in the trough (10) and will not be able to get at them, due to the small size of the opening “o” and gap “g”. Thus trough (10) does not become a feeding trough for the birds, which would only add to the bird problem, not reduce it.

The scope of the described invention is intended to include all embodiments coming within the meaning of the following claims. The foregoing examples illustrate useful forms of the invention, but are not to be considered as limiting its scope, as those skilled in the art will be aware that additional variants and modifications of the invention can readily be formulated without departing from the meaning of the following claims.

What is claimed is:

1. An In-Ground barrier for blocking insects and rodents FOD access to runways comprising a trough having a bottom and, contiguous thereto, oppositely disposed first and second upright walls, a downwardly inclined ramp mounted to an upper edge of said first wall, downwardly inclined into said trough at a first angle, and a cantilevered frangible lid mounted at an upper edge of said second wall so as to define an opening into said trough from said upper edge of said first wall, a lowermost edge of said ramp cantilevered into said trough without touching said bottom or said second wall, and defining a gap between said lowermost edge of said ramp and said second wall, and wherein said lid and said ramp overlap when viewed in a birds-eye aerial view from above so as to occlude, from said aerial view, a view of said bottom of said trough, whereby FOD entering said opening fall through said gap in to said trough so as to reside on said bottom unable to climb from said trough by a blocking operation of said ramp and said lid, and whereby the FOD in said trough remain unseen from said aerial view.

2. In-Ground barrier of claim 1, wherein said top lid is frangible, so as to be collapsible, and dimensioned so that upon said collapse, a free edge of said lid, distal from said second wall lands on said upper edge of said first wall.

3. In-Ground barrier of claim 1, wherein said second wall is adapted to be an inner wall, innermost relative to a runway.

4. In-Ground barrier of claim 1, wherein said trough has a width, and wherein said lid has a width, and wherein the width of said trough is substantially equal to the width of said lid.

5. In-Ground barrier of claim 1, wherein the width of said ramp is less that the width of said lid.

6. In-Ground barrier of claim 1, wherein said lid forms an angle α to a horizontal and said ramp forms an included angle β to said first wall, and wherein said angle β is in the range of 15-60°, and wherein said angle α is in the range of 105-150°.

7. In-Ground barrier of claim 6, wherein said angle α is equal to substantially said angle β plus 90°.

8. In-Ground barrier of claim 1, wherein said bottom, walls, lid and ramp in said trough are fabricated from a low-friction material to reduce traction for FOD insects in said trough to crawl out of said trough.

9. In-Ground barrier of claim 1, wherein said trough further comprises at least one drainage channel.

10. A method of using the In-Ground barrier of claim 1, comprising providing said barrier of claim 1, mounting said barrier into a perimeter of a runway or taxiway so that said upper edge of said first wall is substantially flush to a ground surface of said perimeter and said second wall is closest to the runway, so as to dispose said first wall away from the runway.

11. The method of claim 10, wherein the FOD insects are exterminated when in said trough.

12. The method of claim 10, wherein said trough is installed in said perimeter so as to substantially parallel and adjacent edge of the runway or taxiway.

13. The method of claim 10, wherein said barrier is installed between runway lights around the runway.
